(19) United States
(12) Patent Application Publication
(10) Pub. No.: US 2014/0182717 A1
(43) Pub. Date: Jul. 3, 2014

(54) System for Increasing the Efficiency of a Water Meter

(71) Applicant: Flow Dynamics, LLC, Encinitas, CA (US)

(72) Inventor: Richard K. Edgeworth, Tampa, FL (US)

(73) Assignee: Flow Dynamics, LLC, Encinitas, CA (US)

(21) Appl. No.: 14/202,371

(22) Filed: Mar. 10, 2014

Related U.S. Application Data
(63) Continuation-in-part of application No. 12/946,897, filed on Nov. 16, 2010, now Pat. No. 8,707,981.

(51) Int. Cl. F16K 1/32

(52) U.S. Cl. CPC F16K 1/32
USPC 137/540

(57) ABSTRACT

Disclosed is a system and an associated valve assembly that are adapted to increase the efficiency of an upstream water meter. By way of the valve assembly entrained water bubbles can be removed from a water supply. This, in turn, increases the density of the water running through the water meter. This ensures that the water meter is not inaccurately including entrained air as metered water. The result is more accurate water readings and reduced utility bills.

### CROSS-REFERENCE TO RELATED APPLICATIONS

This application claims priority to, and is a continuation-in-part of, U.S. patent application Ser. No. 12/946,897 filed on Nov. 16, 2010, and entitled “System for Increasing the Efficiency of a Water Meter.” The contents of this co-pending application are fully incorporated herein for all purposes.

### BACKGROUND OF THE INVENTION

1. Field of the Invention

This invention relates to a water valve. More specifically, the present invention relates to a valve assembly and an associated system for increasing water density and improving the accuracy of a water meter.

2. Description of the Background Art

The use of airflow regulating assembly is known in the art. For example, U.S. Pat. App. 2009/0289207 to Barreda discloses a valve assembly that is adapted to be disposed within a water supply line. The valve assembly is structured to reduce or significantly eliminate the passage of air, separate from water flow, through the meter. The valve body includes a sealing structure which is biased under a predetermined force into sealing relation with an inlet of the interior channel. The predetermined force is sufficient to prevent displacement of the sealing structure out of the sealing relation with the inlet, but insufficient to prevent displacement of the sealing structure when force from a normal water flow is exerted thereon. As a result, any air flow within the water supply line will be compressed or otherwise disbursed and prevented from passing, independently, through the meter, thereby preventing unnecessary charges being made to the metered facility.

Although the device of Barreda is sufficient to achieve its stated objective, it is lacking in many respects. The valve assembly of Barreda is needlessly complex with an excess number of moving parts. Moreover, the number of interconnected moving parts requires the device to be lubricated. This lubrication can result in the contamination of the associated drinking water. The system of Barreda is also problematic insomuch as its valve assembly must be installed upstream of the meter assembly. Retrofitting a valve assembly upstream of a water meter poses several logical, legal, and safety related issues. The system of the present invention is aimed at overcoming these and other shortcomings of the Mauricio device.

### SUMMARY OF THE INVENTION

It is therefore an object of the present invention to provide a system for increasing the density of water running through a meter to thereby increase the accuracy of the meter.

It is another object of the present invention to compress the air out of the water as it is being metered.

A further object of the present invention is to provide a valve assembly for increasing the efficiency of an upstream water meter.

Still yet another object of the present invention is to provide a valve assembly that is constructed from self-lubricating polymers to thereby reduce wear ten-fold and avoid the need for external lubricants.

Yet another object of the present invention is to provide a valve construction that eliminates turbulence within water passing there through.

A further object of the present invention is to provide an improved valve construction with a minimal number of moving parts to thereby increase the life cycle of the valve and eliminate the need for repair and maintenance.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a diagram illustrating the system of the present invention.

FIG. 2 is a cross-sectional view of the valve assembly of the present invention.

FIG. 3 is a perspective cross sectional view of the valve assembly of the present invention.

FIG. 4 is a detailed view of the valve stem and valve disc of the present invention.

FIG. 5 is a perspective view of the valve housing of the present invention.

FIG. 6 is a perspective cross sectional view of the valve housing of the present invention.

FIG. 7 is a disassembled view of the components of the valve assembly of the present invention.

FIG. 8 is a cross-sectional view of an alternative valve assembly of the present invention.

FIG. 9 is a cross-sectional view of an alternative valve assembly of the present invention.

Similar reference characters refer to similar parts throughout the several views of the drawings.

### DETAILED DESCRIPTION OF THE PREFERRED EMBODIMENT

The present invention relates to a system and an associated valve assembly that are adapted to increase the efficiency of an upstream water meter. By way of the valve assembly entrained water bubbles can be removed from a water supply. This, in turn, increases the density of the water running through the water meter. This ensures that the water meter is not inaccurately including entrained air as metered water. The result is more accurate water readings and reduced utility bills. The various components of the present invention and the manner in which they interrelate will be described in greater detail hereinafter.

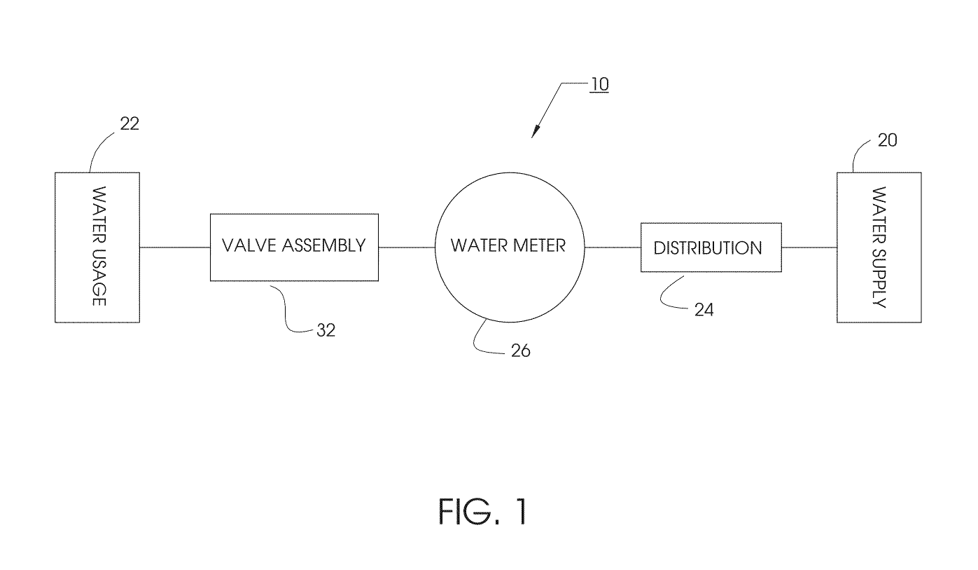

FIG. 1 is a diagram illustrating the system 10 of the present invention. This system includes five primary components. The first component is a water supply 20. The water supply 20 can be, for example, the water supply or reservoir maintained by a utility or municipality. The reservoir may store a large volume of preferably potable water for distribution to a number of consumers. These various water consumers 22 may be, for example, dwellings such as houses or office buildings but may also include individual water fountains or other water outlets that are accessed by individuals. The second element in the system is a distribution network 24. This distribution network 24 may take the form of a number of water supply lines and/or return lines that are interconnected to the water supply reservoir. This distribution network interconnects the plurality of water consumers 22. For the purpose of a frame of reference, the water supply 20 is upstream from the downstream distribution network 24.

The system 10 further includes a water meter 26 that is interconnected and in line with the distribution network 24 upstream from an individual water consumer 22. The water meter 26 may be of a conventional construction such as a float meter, multi-jet meter, turbine meter or positive displacement meter. Those of ordinary skill in the art will recognize other types of water meters that can be used in conjunction with the present invention. The water meter 26 is typically maintained by the utility or municipality and is operable to measure the volume of water used by the individual consumer over a pre-determined period of time. As such, the water meter 26 is instrumental in determining an individual user's water bill.

The present invention further includes a valve assembly 32 that is positioned downstream of the water meter 26 and is intermediate to the water meter 26 and the intake to a particular water consumer 22. As will be described in greater detail hereinafter, the valve assembly 32 includes a spring biased plunger that is triggered at a predetermined water pressure. Namely, water is permitted to pass into the individual user's dwelling only after a build-up of a sufficient water pressure. This has the effect of driving out any entrained water and increasing the water density through the meter 26. This, in turn, increases the efficiency of the water meter 26 and ensures that the consumer is paying only for the water they use as opposed to water and entrained air. Water meters measure volume, regardless of whether that volume includes water alone or water with entrained air. More water mass can be created with pressure, by displacing the air and shrinking the air molecules.

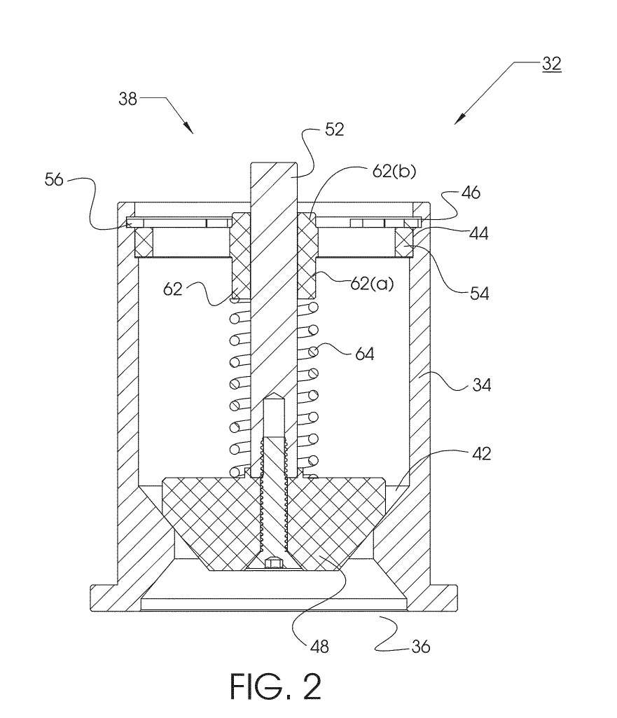

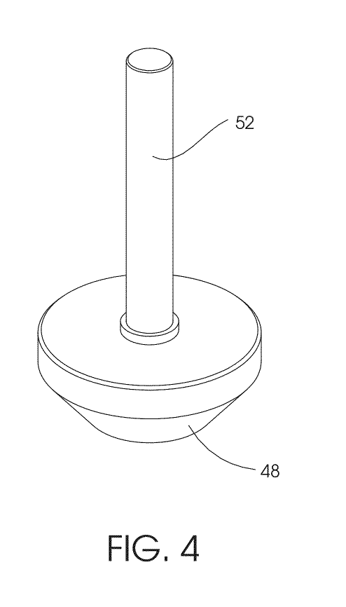

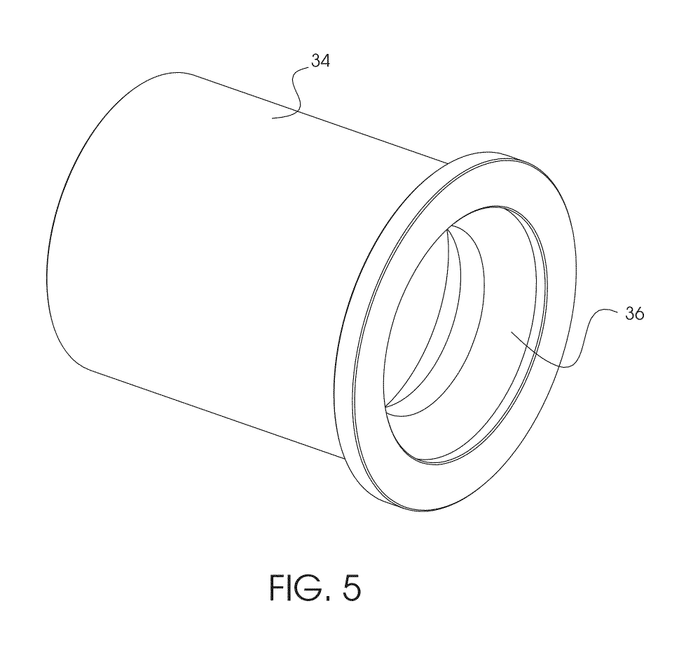

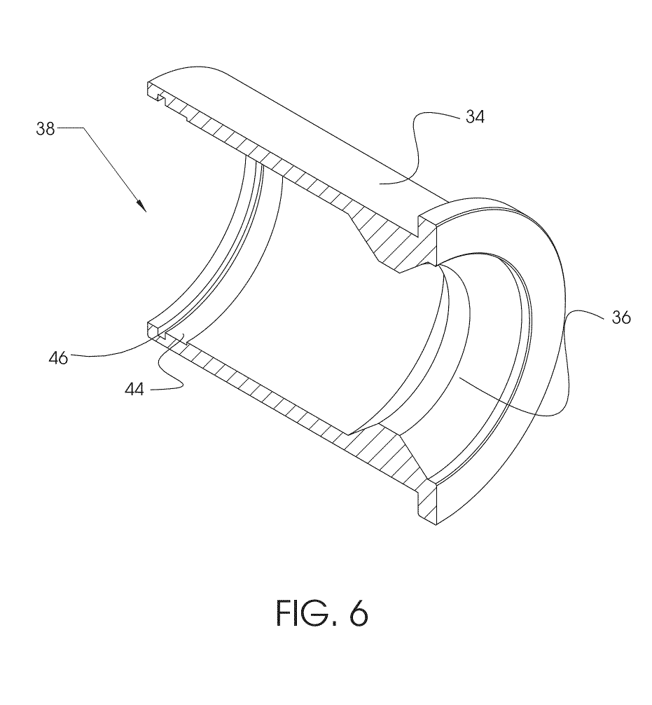

The specifics of the valve assembly 32 are described in conjunction with FIGS. 2 through 7. These figures illustrate a cylindrical valve housing 34 having a forward valve inlet 36 and a rearward valve outlet 38. This valve housing 34 is preferably constructed from a self-lubricating polymer such as Vesconite™ as well as Delrin™. The valve housing 34 further includes a tapered valve seat 42 that is positioned adjacent to inlet 36. As described in greater detail hereinafter, closure mechanisms are secured adjacent the rearward valve outlet 38. In this regard first and second cylindrical recesses (44 and 46) are formed within the interior wall of the valve housing 34 immediately adjacent the outlet 38.

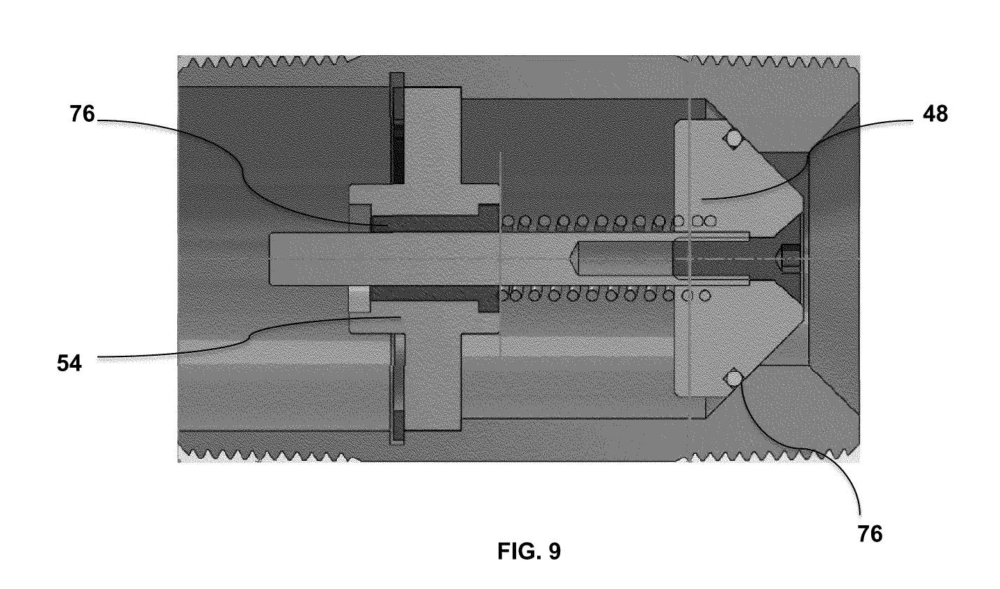

The valve 32 can be opened and closed by way of a valve disc 48. Again, this valve disc 48 is preferably formed from a self-lubricating polymer which may be the same polymer used for the cylindrical valve housing 34. The valve disc 48 includes a tapered extent and is generally in the shape of a frustro cone. As illustrated in FIG. 2, the taper of the valve seat 42 approximately matches the taper of the valve disc 48 so that the two can be placed in a fluid tight seal. The use of self-lubricating polymers eliminates the need for any gasket or sealing rings. Nonetheless, as indicated in the alternative embodiment of FIG. 9, a gasket can be included about the periphery of valve disc 48 to improve the seal against valve seat 42. In either event, the valve disc 48 includes a seated orientation where it is in positive and sealing contact with the valve seat 42 to prevent the flow of water therethrough. The sealing contact between disc 48 and seat 42 prevents water from flowing backwards through the assembly 32. Namely, the seal prevents the reverse flow of water out of inlet 36. The valve disc 48 also includes an unseated orientation wherein it is spaced a distance from the valve seat 42. The unseated orientation is generally done against the bias of a spring.

With continuing reference to FIG. 2, the valve shaft 52 is depicted. The valve shaft is generally defined with a forward end, a rearward end and an intermediate extent therebetween. The forward extent of the valve shaft includes a female threaded extent which is adapted to receive a threaded fastener. The forward extent can alternatively be fitted with a flange appropriately sized for the serving meter. Additionally the valve disc 48 includes a centrally located threaded passage. In this manner a threaded or flanged fastener can be used to secure the valve disc 48 to the forward end of the valve shaft 52. This threaded or flanged interconnection permits the valve disc 48 to be removed if needed.

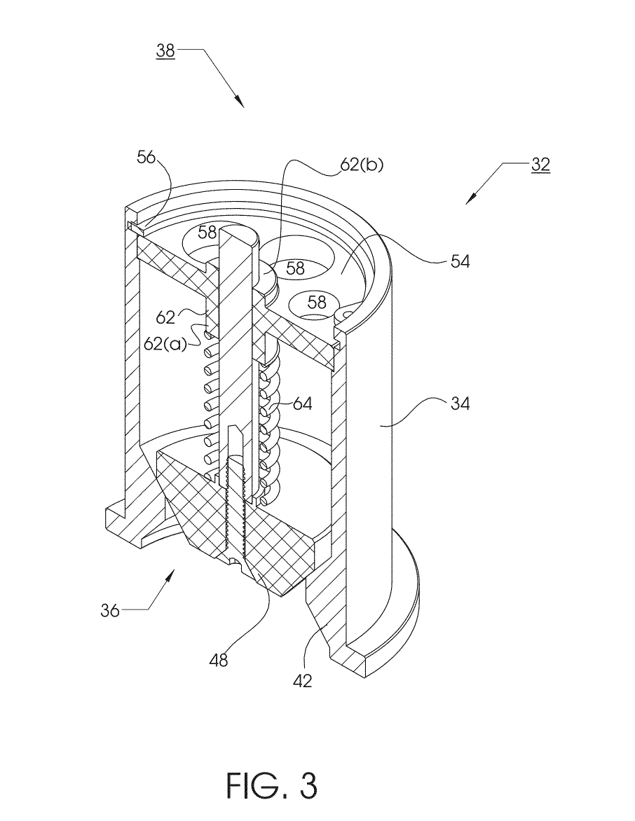

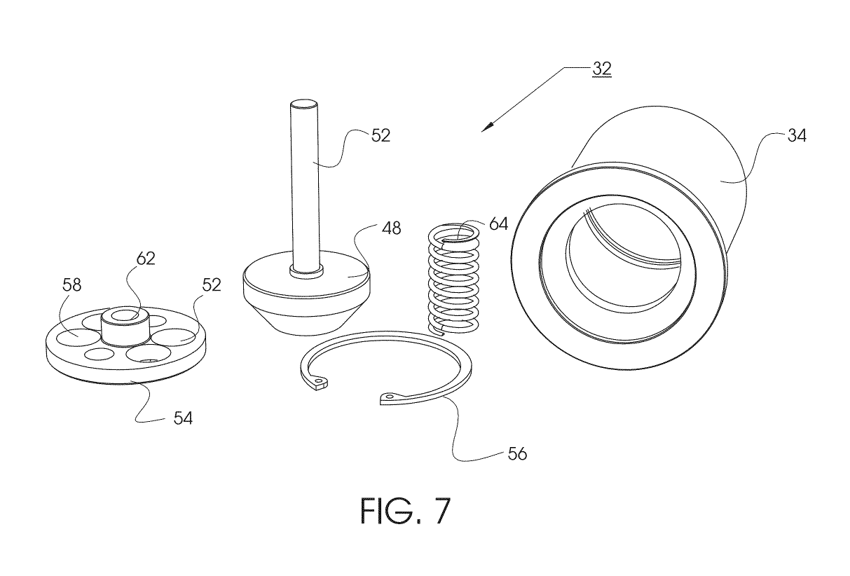

The rear end of the valve assembly 34 includes a retainer 54 and a locking ring 56. The retainer 54 is generally disc shaped and fits within the first recess 44 of the valve housing. As illustrated in FIG. 7, the retainer 54 includes a number of circular openings 58. The collective cross section of these circular openings 58 is selected to match the diameter of the intake 36. As such, these cylindrical openings 58 permit water flowing through the intake 36 to be adequately routed through the outlet 38 of the valve. With reference to FIGS. 2 and 3, the shoulder 62 of the retainer 54 is illustrated. This retainer 62 includes a central axial passage as well as opposing first and second ends (62(a) and 62(b)). As noted in FIG. 2, the first end 62(a) of the shoulder 62 is substantially longer than the second end 62(b). The axial opening within the shoulder is adapted to slideably receive the valve shaft 52 and guide it as it reciprocates back and forth. A locking ring 56 is then used to secure the retainer 54. The locking ring 56 can be a spring biased ring with a break along its periphery such that it can be placed within the second recess 46 in a compressed orientation.

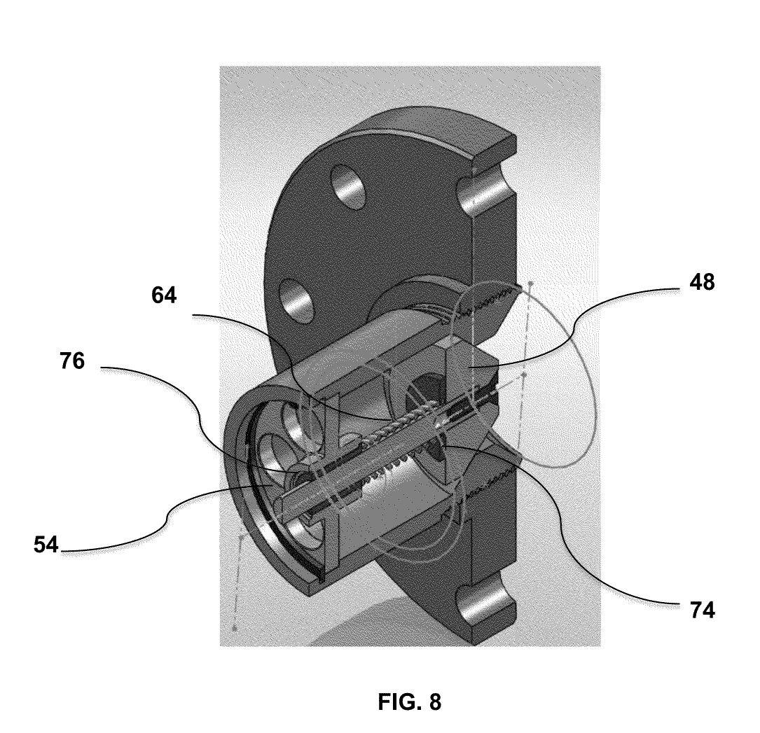

A coil spring 64 is positioned above the intermediate extent of the valve shaft 52. The coil spring 64 has a first end which is in contact with one of the shoulders (62(a) or 62(b)) of the retainer 54 and a second end which is in contact with the valve disc 48. As described below in connection with FIG. 8, a washer can alternatively be positioned between the second end of the spring 64 and the valve disc 48. Coil spring 64 acts to bias the valve disc 48 into a seated orientation. However, the tension within the spring 64 can be changed by selecting which of the two shoulders (62(a) or 62(b)) is in contact with the end of the spring 64. Namely, if a tight spring tension is required, the first shoulder 62(a) can be placed in contact with the spring 64 as noted in FIG. 2. Alternatively, if a lesser spring tension is required, the retainer 54 can be removed turned around such that the shorter shoulder 62(b) is in contact with the spring. Further adjustments to spring tension can be achieved via the placement of the washer between spring 64 and disc 48 as described in more detail hereinafter.

With this arrangement, water contacting the valve disc 48 will be prevented from flowing through the valve 34 unless it exceeds a predetermined threshold pressure as dictated by the spring tension. Once this threshold water pressure is achieved the valve 48 will unseat and water will pass through the valve 34. It is envisioned that the water will repetitively exceed and not exceed this threshold water pressure. This will cause the valve disc 48 to repetitively open and close. This, in turn, results in the water upstream from the valve from becoming more dense and driving out any entrained water.

FIGS. 8 and 9 illustrate alternative embodiments of the present invention. These embodiments are the same in most respects to the embodiments of FIGS. 1-7. However, in the embodiment of FIG. 8, a washer 74 has been positioned between the end of spring 64 and the valve disc 48. Washer 74 provides a further means for varying the tension of spring 64. Namely, washer 74 acts to shorten the length of spring 64, and thereby increase its spring tension. Thus, by utilizing washer 74, a greater pressure will be required to unseat valve disc 48. One or more of these washers 74 can be utilized between the end of spring 64 and the associated contact point of the valve disc 48. The washers can be positioned at either or both ends of spring 64. The washers can be any specified thickness and can be used singly or in various combinations to provide an even greater variance to the spring tension. FIG. 8 also shows an additional bearing positioned between the interior of retainer 62 and the shaft 52. This bearing reduces wear on the interior of retainer 62 as shaft 52 reciprocates within retainer 62.

FIG. 9 illustrates yet another embodiment. As illustrated, this embodiment employs an elastomeric O-ring 76 about the periphery of valve disc 48. O-ring 76 helps promote a water tight seal between disc 48 and the surrounding housing when disc 48 is seated. Valve disc 48 may include a circular groove for accepting and seating O-ring 76. In this manner, O-ring 76 helps prevent back flow during use of the valve. Namely, due to the seal between disc 48 and seat 42, water is prevented from flowing out of the inlet of the assembly. It is understood that O-ring 76 and washer 74 can be used in conjunction with one another in the same embodiment.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A valve assembly comprising:
a cylindrical valve housing, the valve housing have a forward valve inlet and a rearward valve outlet, a tapered valve seat positioned adjacent the valve inlet, first and second cylindrical recesses positioned adjacent the valve outlet, the valve housing being constructed from a self-lubricating polymer;
a valve disc positioned within the valve housing, the disc being tapered along its length, wherein the taper of the valve seat matches the taper of the valve disc, the valve disc having a seated orientation wherein it is in contact with the valve seat and an unseated orientation wherein the valve disc is spaced from the valve seat, the valve disc being constructed from a self-lubricating polymer;
a valve shaft having a forward end, a rearward end, and an intermediate extent therebetween, a threaded fastener securing the valve disc to the forward end of the valve shaft;
a retainer secured within the first recess of the valve housing, the retainer including a series of circular apertures to permit the flow of fluid through the valve outlet, the retainer further including a centrally located shoulder having an axial passage, the shoulder having first and second ends, with the first end being longer than the second end, the valve shaft slidably positioned within the axial passage;
a locking ring secured within the second recess of the valve housing and operable to lock the retainer within the valve housing;
a coil spring positioned about the intermediate extent of the valve shaft, the coil spring having a first end in contact with the shoulder of the retainer and a second end in contact with the valve disc, wherein the spring tension can be varied by selectively placing either the first or second end of the shoulder in contact with the spring;
whereby water flowing from the inlet to the outlet of the valve assembly contacts the valve disc and further wherein a pre-determined water pressure is sufficient to unseat the valve disc and thereby displacing air bubbles out of the upstream water and increase the density of the water.

2. A valve assembly comprising:
a cylindrical valve housing, the valve housing have a forward valve inlet and a rearward valve outlet, a tapered valve seat positioned adjacent the valve inlet;
a valve disc positioned within the valve housing, the disc being tapered along its length, the valve disc having a seated orientation wherein it is in contact with the valve seat and an unseated orientation wherein the valve disc is spaced from the valve seat;
a valve shaft having a forward end, a rearward end, and an intermediate extent therebetween, the valve disc coupled to the forward end of the valve shaft;
a retainer secured adjacent the rearward valve outlet, the retainer including a series of apertures to permit the flow of fluid through the valve outlet, the retainer further including a centrally located shoulder having an axial passage, the valve shaft slidably positioned within the axial passage;
a spring positioned along the intermediate extent of the valve shaft, the spring having a first end in contact with the shoulder of the retainer and a second end in contact with the valve disc;
whereby water flowing from the inlet to the outlet of the valve assembly contacts the valve disc and further wherein a pre-determined water pressure is sufficient to unseat the valve disc and thereby displacing air bubbles out of the upstream water and increase the density of the water.

3. The valve assembly as described in claim 2 wherein the valve is used in connection with a conventional water meter.

4. The valve assembly as described in claim 2 wherein the valve housing is constructed from a self-lubricating polymer.

5. The valve assembly as described in claim 2 wherein the valve disc is constructed from a self-lubricating polymer.

6. The valve assembly as described in claim 2 wherein the shoulder includes first and second ends of varying length and wherein the spring tension can be varied by selectively placing the spring in contact with either the first or the second ends.

7. The valve assembly as described in claim 2 further comprising a washer positioned between the spring and the valve disc and wherein the washer functions in varying the tension of the spring.

8. The valve assembly as described in claim 2 further comprising a water meter for measuring the volume of water passing therethrough, wherein the valve assembly is positioned downstream of the water meter.

9. A valve assembly comprising:
a cylindrical valve housing, the valve housing have a forward valve inlet and a rearward valve outlet, a tapered valve seat positioned adjacent the valve inlet;
a valve disc positioned within the valve housing and having a seated orientation wherein it is in contact with the valve seat and an unseated orientation wherein the valve disc is spaced from the valve seat;
a valve shaft having a forward end, a rearward end, and an intermediate extent therebetween, the valve disc coupled to the forward end of the valve shaft;
a retainer secured adjacent the rearward valve outlet, the valve shaft slidably positioned within the retainer;
a spring associated with the valve shaft and extending between the retainer and the valve disc, the spring having a spring tension.
means for varying the spring tension.

10. The valve assembly as described in claim 9 wherein the means for varying the spring tension is a washer.

11. The valve assembly as described in claim 9 wherein the means for varying the spring tension is the retainer.

12. The valve assembly as described in claim 9 further comprising an O-ring positioned about the periphery of the valve disc, wherein the O-ring helps promote a water tight seal between valve disc and the valve seat.

13. The valve assembly as described in claim 2 further comprising an elastomeric seal positioned about the periphery of the valve disc, wherein the seal helps prevent backflow.
